(19) United States
(12) Patent Application Publication
(10) Pub. No.: US 2025/0008619 A1
(43) Pub. Date: Jan. 2, 2025

(54) Electromagnetic Energy Heating System

(71) Applicant: Green RF Solutions L.L.C., Haskell, NJ (US)

(72) Inventor: Vincent Anthony Bravo, Haskell, NJ (US)

(73) Assignee: Green RF Solutions L.L.C., Haskell, NJ (US)

(21) Appl. No.: 18/752,449

(22) Filed: Jun. 24, 2024

Related U.S. Application Data
(60) Provisional application No. 63/524,689, filed on Jul. 2, 2023.

(51) Int. Cl. H05B 6/80

(52) U.S. Cl. CPC H05B 6/804; H05B 2206/044

(57) ABSTRACT

A zero-carbon footprint heating system for a fluid and conditioned air uses electromagnetic energy created by one or more magnetrons operated by high voltage transformers. The heating system includes nested fluid filled conduits in communication with the magnetrons for heating of the fluid. The heated fluid passes through a heat exchanger for heat transfer to the air being conditioned by the system.

### BACKGROUND OF THE INVENTION

The present application claims the benefit of priority to U.S. Provisional application No. 63/524,689 filed on Jul. 2, 2023 which is incorporated herein in its entirety.

The present invention relates in general to an electromagnetic energy heating system adapted for residential, commercial, and industrial applications. More particular, by way of an example, the invention relates to the use of microwave energy created by one or more magnetrons as a heat source for heating fluids to an elevated temperature for heat exchange applications.

Electromagnetic energy such as in the form of microwaves generated by a magnetron has been known for use in heating systems having various designs. By way of example, United States Pub. No. 2005/0139594 discloses the application of a magnetron in a water heater or boiler. U.S. Pat. No. 4,956,534 discloses the application of a magnetron in a heat exchanger having a frustoconical shape. U.S. Pat. No. 6,858,824 discloses a microwave domestic hot water and radiant heating system. U.S. Pat. No.8,901,468 discloses a heating system using multiple magnetrons for heating a fluid within a single cone shaped coiled tube.

The present invention provides a heating system using electromagnetic energy generated from one or more magnetrons in a manner heretofore unknown, which is described in the following detailed description.

### BRIEF SUMMARY OF THE INVENTION

The present invention is generally directed to an electromagnetic energy heating system using one or more transformer operated magnetrons for generating microwave energy to produce economical and energy saving heat. For example, the system can be figured to use microwave energy to provide domestic hot water, as well as to heat a building, structure or other space to be conditioned in residential, commercial, and industrial applications.

In accordance with one embodiment of the present invention, there is disclosed an electromagnetic energy heating system constructed from a housing forming a chamber in communication with an air inlet and an air outlet; a magnetron heating system arranged within the chamber, wherein the magnetron heating system comprises a pair of nested tubing containing a fluid and at least one magnetron for creating electromagnetic energy in communication with the pair of nested tubing for heating the fluid therein; a transformer operatively connected to the magnetron for the operation of the magnetron for creating electromagnetic energy; an air to liquid heat exchanger in communication with the air outlet; and a blower for directing air from the air inlet over the air to liquid heat exchanger to the air outlet.

In accordance with one embodiment of the present invention, there is disclosed an electromagnetic energy heating system comprising: a housing forming a chamber in communication with an air inlet and an air outlet; a magnetron heating system arranged within the chamber, wherein the magnetron heating system comprises a pair of nested tubing containing a fluid, a first magnetron coupled to a first waveguide in communication with the nested tubing at a first end of the chamber and a second magnetron coupled to a second waveguide in communication with the nested tubing at a second end of the chamber, wherein the first and second magnetrons create electromagnetic energy for heating the fluid in the nested tubing; first and second transformers operatively connected to a respective one of the first and second magnetrons for the operation of the magnetrons for creating electromagnetic energy; an air to liquid heat exchanger in communication with the air outlet; and a blower for directing air from the air inlet over the air to liquid heat exchanger to the air outlet.

In accordance with one embodiment of the present invention, there is disclosed an electromagnetic energy heating system comprising: a housing forming a chamber in communication with an air inlet and an air outlet; a magnetron heating system arranged within the chamber, wherein the magnetron heating system comprises at least a pair of nested tubing containing a fluid, a first magnetron coupled to a first waveguide in communication with the nested tubing at a first end of the chamber, a second magnetron coupled to a second waveguide in communication with the nested tubing at a second end of the chamber, a third magnetron coupled to a third waveguide in communication with the nested tubing at the first end of the chamber and a fourth magnetron coupled to a fourth waveguide in communication with the nested tubing at the second end of the chamber, wherein the first, second, third and fourth magnetrons create electromagnetic energy for heating the fluid in the nested tubing; first, second, third and fourth transformers operatively connected to a respective one of the first, second, third and fourth magnetrons for the operation of the magnetrons; an air to liquid heat exchanger in communication with the air outlet; and a blower for directing air from the air inlet over the air to liquid heat exchanger to the air outlet.

In accordance with one embodiment of the present invention, the pair of nested tubing has a polygonal shape, e.g. rectangular, which may be concentrically arranged. In accordance with another embodiment of the present invention, the tubing is formed into a plurality of helical coils or a plurality of alternating back and forth vertical or horizontal fluid flow paths. In accordance with another embodiment of the present invention, there includes a preheating tank and a booster tank coupled to the nested tubing for respectively preheating and boosting the temperature of the fluid in the nested tubing

### BRIEF DESCRIPTION OF THE DRAWINGS

The subject matter regarded as the invention is particularly pointed out and distinctly claimed in the concluding portion of the specification. The invention, however, both as to organization and method of operation, together with features, objects and advantages thereof may best be understood by reference to the following detailed description when read with the accompanying drawings in which:

FIG. 1 is a perspective view of a magnetron heating system adapted for heating a fluid to be supplied to a heat exchanger in accordance with one embodiment, as illustrated within a closed housing.

FIG. 2 is a perspective view of the magnetron heating system in accordance with one embodiment showing an open access door.

FIG. 3 is a perspective view, with partial cut away section, of a magnetron heating unit in accordance with one embodiment.

FIG. 4 is a perspective view, looking from above, of nested or concentrically arranged helical coils of tubing.

FIG. 5 is a perspective view, looking from below, of nested or concentrically arranged helical coils of tubing.

FIG. 6 is a perspective view of the partially assembled magnetron heating system in accordance with one embodiment.

FIG. 7 is another perspective view of the partially assembled magnetron heating system in accordance with one embodiment.

FIG. 8 is another perspective view of the partially assembled magnetron heating system in accordance with one embodiment.

FIG. 9 is a perspective view of the assembled magnetron heating system in accordance with one embodiment.

FIG. 10 is a perspective view of the high voltage supply fluid cooling tank in accordance with one embodiment.

FIG. 11 is a perspective view of the high voltage supply fluid cooling and heat recovery system in accordance with one embodiment.

FIG. 12 is a perspective view showing the airflow path through the housing of the heating system as shown in FIG. 1 in accordance with one embodiment.

FIG. 13 is a perspective view of the heating system having a regenerative heat recovery system in accordance with one embodiment.

FIG. 14 is a perspective view of the fluid carrying tubing in accordance with another embodiment.

FIG. 15 is a perspective view of the fluid carrying tubing in accordance with another embodiment.

### DETAILED DESCRIPTION OF THE PREFERRED EMBODIMENTS

In describing the preferred embodiments of the invention illustrated in the drawings, specific terminology will be used for the sake of clarity. However, the invention is not intended to be limited to the specific terms so used, and it is to be understood that each specific term includes all equivalence that operate in a similar manner to accomplish a similar purpose.

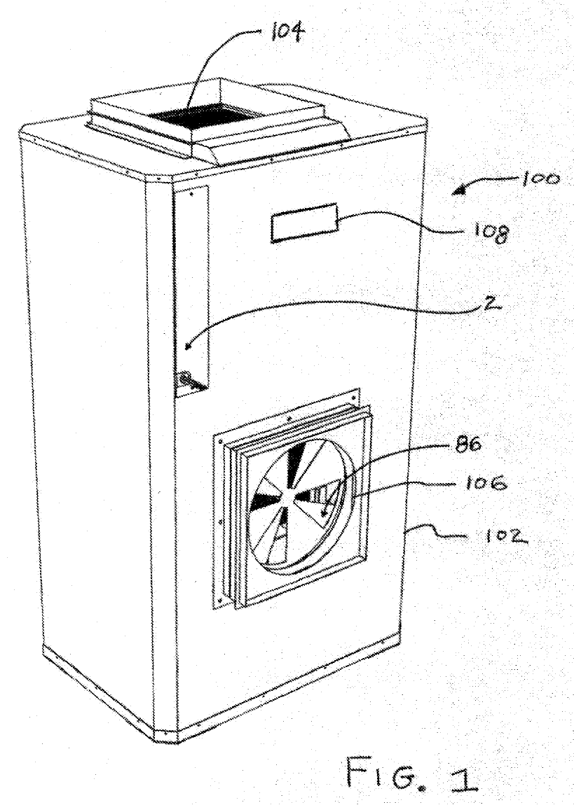

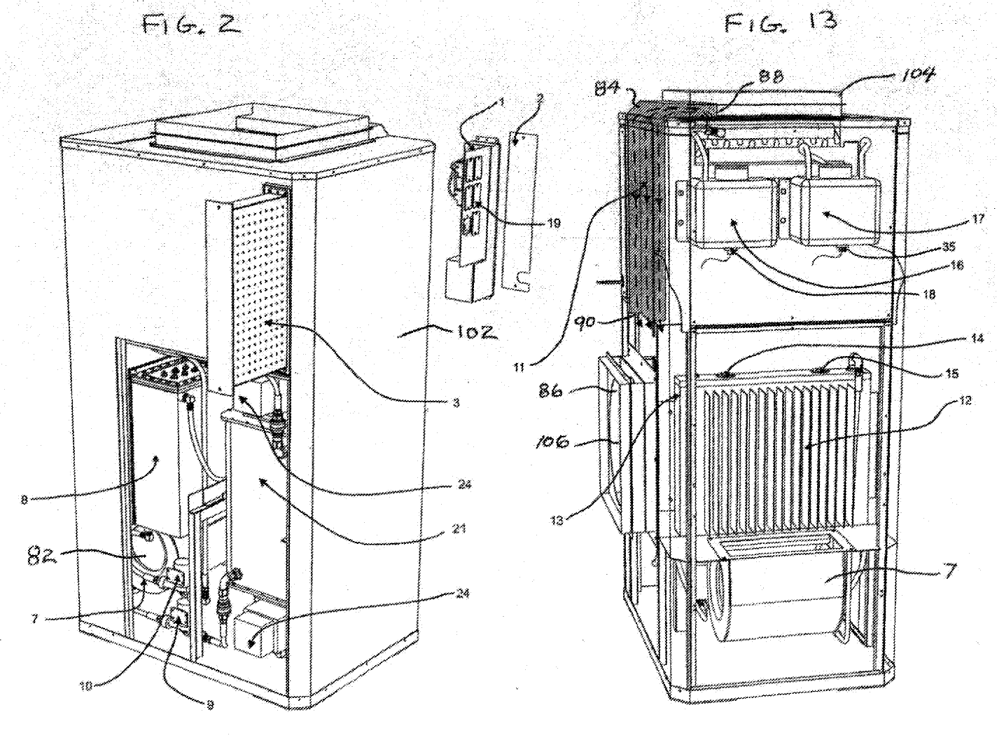

Referring now to FIGS. 1 and 2, wherein like reference numerals represent like elements, there is shown an electromagnetic energy heating system in accordance with one embodiment of the present invention generally designated by reference numeral 100. The heating system 100 includes a housing 102 constructed to contain the operative components, assemblies, sub-assemblies, systems, and subsystems as to be described hereinafter. The housing 102 is constructed to include a discharge air outlet 104 and a return air inlet 106. The air inlet 106 may be provided with a servo controlled return air damper 86. Although the air outlet 104 is illustrated arranged at the top of the housing 102, and the air inlet 106 is arranged on a side panel of the housing, other arrangements of the outlet and inlet are contemplated pursuant to the present invention. Control of air flow distribution within the heating system 100 is accomplished through the use of a variable speed 48V DC blower 7 controlled by the temperature of a fluid heat exchanger 31 and the servo controlled return air damper 86, see also FIG. 12.

In addition, the housing 102 may include a removable service panel shown removed in FIG. 2, to provide access to the interior of the housing for servicing the components, assemblies, sub-assemblies, systems and sub-systems therein. The service panel may be provided with a key lock to prevent access to the interior of the housing by unauthorized individuals.

A source of external operating power connects through power entry box 1 which also contains power relays 19. Power entry box 1 may be mounted within the housing 102 made accessible through a service panel 2. Power is then distributed to an electronics drawer 3 which contains the control circuitry for the heating system 100. Power may be supplied from a 120 V AC line or by solar panels, wind turbines, etc. The electronics drawer 3 may be modular and slide out for easy replacement when being serviced. In another embodiment, the components of the electronics drawer 3 may be mounted within the housing 102 made accessible through the removable service panel (not shown). The control circuitry turns on the appropriate relays 19 for the operating mode at that time. A user control panel 108 having a microprocessor connected to the circuitry of the electronics drawer 3 for the operation of the heating system 100 may optionally be provided if desired on one of the side panels of the housing 102. The operation of the heating system 100 may be controlled manually or programed by the control panel 108, or remotely through a wireless connection to the control panel such as the Internet or through another wired or non-wired network.

The housing 102, in accordance with an embodiment, is substantially sealed except for the air outlet 104 and air inlet 106. That is, the heating system 100 communicates with the surrounding environment substantially through the air outlet 104 and air inlet 106. In this regard, the housing 102 provides a substantially enclosed environment sealed from the surrounding environment where the heating system is placed.

As will be understood from a further description of the heating system 100, the use of electromagnetic energy created by magnetrons does not produce any toxic exhaust or combustion flue gases that require venting to the atmosphere. In other words, the heating system 100 has a zero-carbon footprint. Therefore, there are no combustion flue ducts as conventionally found in gas or oil burning systems. For this reason, the heating system 100 can be placed anywhere within any open or closed area to be occupied without concern of contamination of the breathable air. The absence of combustion flue ducts provides the heating system 100 with a degree of portability for use not only in permanent installations, but in temporary installations such as portable localized heating systems where temporary conditioned heated air is required, for example, at work sights and the like.

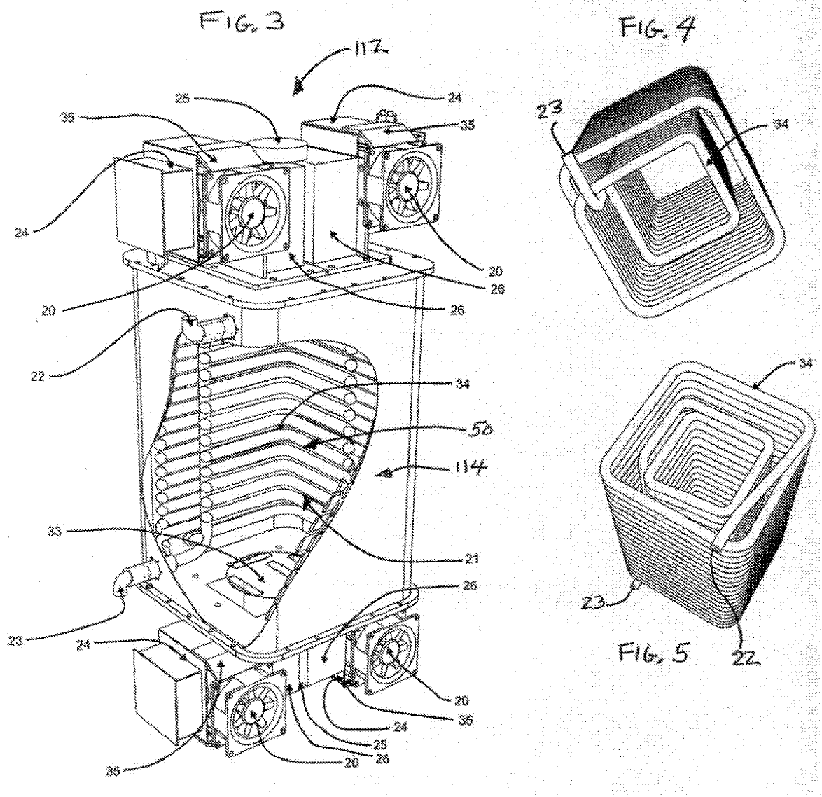

The heart of the heating system 100 is a magnetron heating system 112 as shown in FIG. 3. The magnetron heating system 112 includes a housing 114 defining an internal magnetron chamber 21 as shown through a cut out portion of the housing for illustration purposes. The housing 114 may be polygonal in shape, by way of example only rectangular, formed from a double wall construction having an air gap therebetween. The air gap provides radio frequency shielding from the electromagnetic energy created by the magnetrons, as well as thermal insulation. In the preferred embodiment, the housing 114 is constructed from stainless steel or other suitable materials.

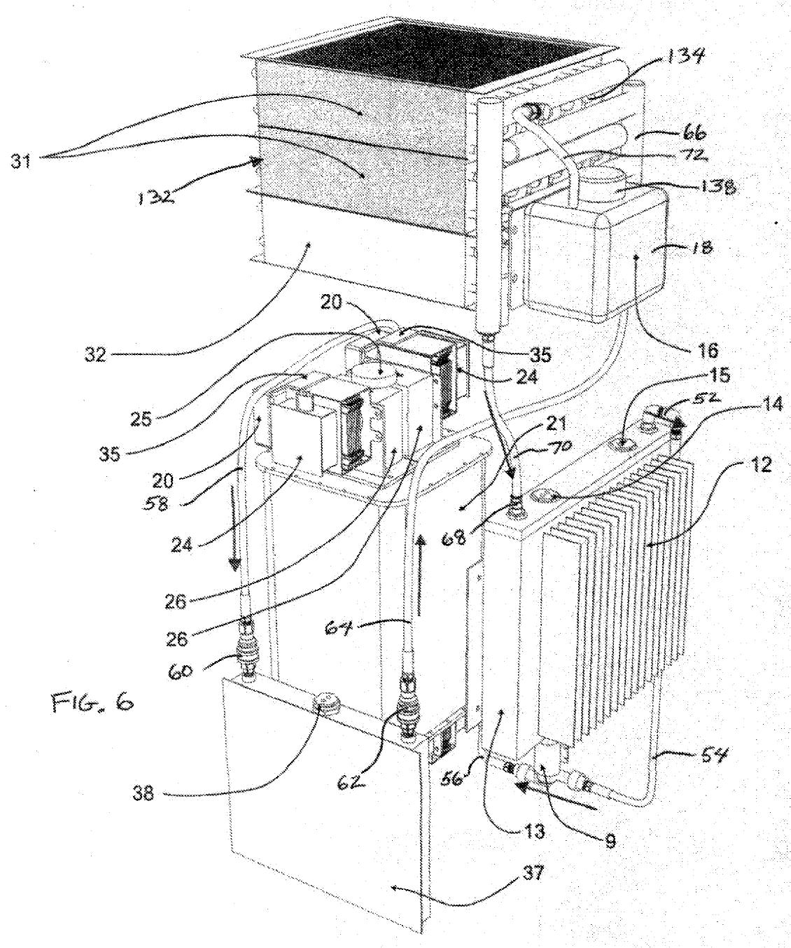

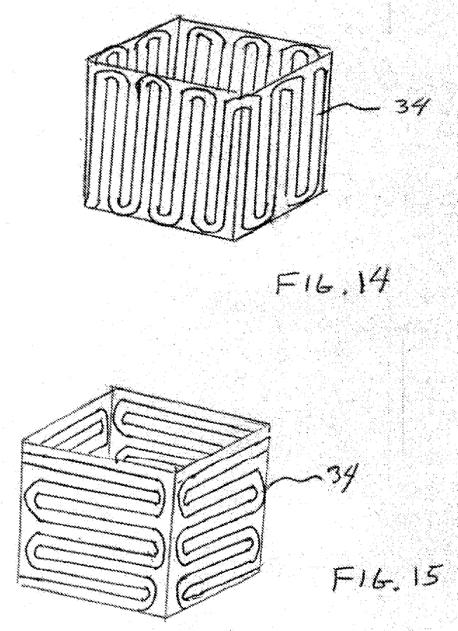

A microwave transparent heating unit 50 is arranged within the internal chamber 21 of the housing 114. The heating unit 50 in one embodiment is constructed to include an elongated conduit such as tubing 34 formed into a plurality of nested (i.e. having either common or non common centers) arranged forms, e. g., concentrically arranged forms. In the preferred embodiment, the tubing 34 is arranged into helical concentric coils. For the purpose only of the present description, the tubing 34 will be described hereinafter as a helical coil. However, it is contemplated that other forms can be used such as those shown in FIGS. 14 and 15 as to be described hereinafter. The coils of tubing 34 may be formed overall into polygon shaped structures as shown in FIGS. 4 and 5 providing an exposed exterior surface area and an exposed interior surface area within the internal space formed by the coiled tubing. The coiled tubing 34 provides a fluid flow path from its lower inlet end 23 to its upper outlet end 22 extending along the length of the internal chamber 21.

Although the coils of tubing 34 have been described in accordance with the preferred embodiment as having a polygonal shape such as rectangular, it is to be understood that other shapes such as cylindrical, oval and the like can be adopted for use in the magnetron heating system 112. In addition, although two concentric or nested helical coils of tubing 34 have been shown, a greater number of helical coils can be used. In the embodiment shown, the two helical coils of tubing 34 form a single fluid flow path from the inlet end 23 to the outlet end 22. It is contemplated that separate serial or parallel fluid flow paths may be provided by individual helical coils of tubing 34. A tubing support (not shown) may be provided coupled to the coiled tubing 34 to maintain the tubing in its coiled shape.

In accordance with one embodiment, the tubing 34 may be constructed from Teflon having an inside diameter of about 0.375 inches, although larger and smaller inside diameters are contemplated depending upon the size of the magnetron heating system 112 and its intended application. The selected diameter of the tubular 34 allows for complete heating of the tubing by exposure of its exterior and interior surface areas to the electromagnetic energy generated by the magnetrons. In addition to Teflon, the tubing 34 can be constructed of glass or other microwave transparent materials. The advantage of Teflon versus other material is that Teflon has a high dielectric strength which makes it invisible to microwaves. Other advantages are the relatively low absorption of water by Teflon, which maintains its dielectric strength all the time, as well as having a relatively low thermal conductivity. This allows the heat generated by the electromagnetic energy to remain in the fluid flowing through the magnetron heating system 112.

The fluid flowing through the tubing 34 within the internal magnetron chamber 21 is heated by a magnetron system generating electromagnetic energy in the form of microwaves. In the embodiment as show in FIGS. 3 and 9, a pair of waveguides 26 is coupled to the upper end of the housing 114 and a pair of waveguides 26 is coupled to the lower end of the housing 114. A magnetron 24 is received within a housing coupled to the end of each of the waveguides 26. The waveguides 26 direct the electromagnetic energy in the form of microwaves from the magnetrons 24 to the internal chamber 21 at either the upper end or the lower end thereof. More particularly, the upper and lower magnetrons 24 direct microwave energy through the upper and lower waveguides 26 to the external surface area and to the interior surface area of the coiled tubing 34 within the internal chamber 21. By directing microwaves to both the exterior and interior surface areas of the coiled tubing 34 forming the heating unit 50, heating of the fluid therein is more efficient by allowing absorption of electromagnetic energy over substantially the entire surface area of the tubing 34.

The magnetrons 24 are forced air cooled by 12 V DC fans 20 mounted directly on each magnetron by a duct bracket 35. The heated air from the magnetrons 24 can be used to pre-condition the air pulled into the heating system 100 through the return air inlet 106. The internal magnetron chamber 21 may have upper and lower motor 25 driven mode stirrers 33, see FIG. 3, to better distribute the microwave energy from the top and bottom magnetrons 24 to provide better exposure of the microwave energy to the fluid flowing within tubing 34. The magnetrons 24 are monitored individually for over and under current and over temperature. The heating system 100 will shut down for any of these conditions and send a system failure and cause notification to a phone app and/or to the control panel 108.

The heating system 100 has been described as being provided with a pair of upper and lower magnetrons 24. However, it is to be understood that the heating system 100 may incorporate only a single upper magnetron 24 and a single lower magnetron for heating the fluid flowing through the tubing 34. Further, it is also contemplated that only one magnetron 24 can be incorporated into the magnetron heating system 100, arranged either at the upper or lower end of the magnetron heating system 112. Typical, magnetrons are available ranging from 600 watts to 3000 watts in capacity. The size and number of magnetrons will be determined by the size of the space to be heated using the heating system 100 when conditioning a volume of air in a room or the like. By way of example, it is contemplated that a 1500 to 2000 square foot facility will incorporate four magnetrons, each of 1000 watts, arranged as illustrated and described. Likewise, the use of the heating system 100 for heating hot water will incorporate magnetrons of varied capacity and number depending upon the hot water demands of the application.

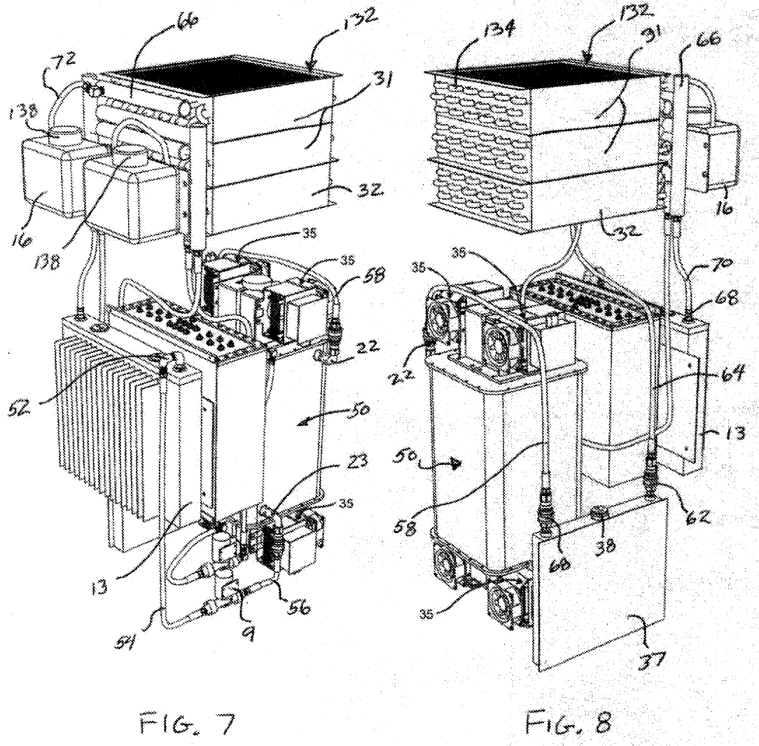

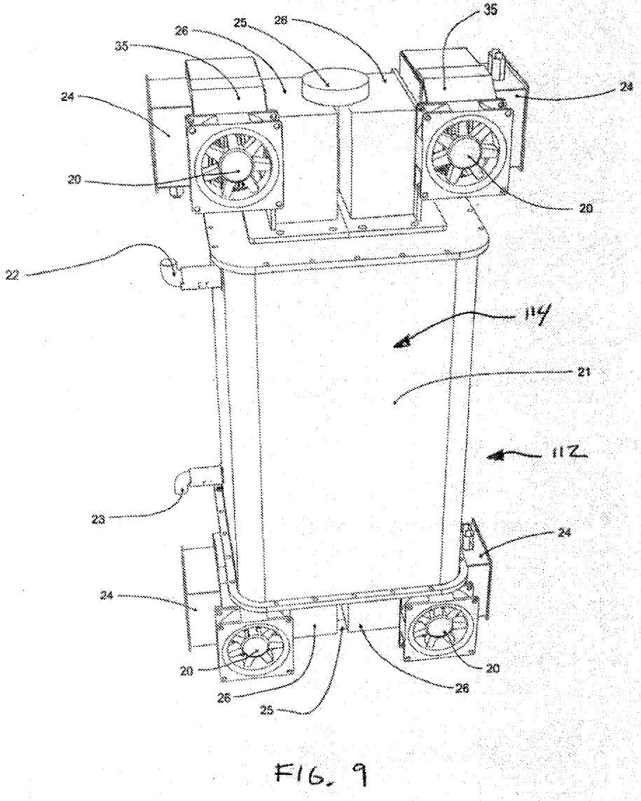

Referring generally to FIGS. 6-8, the heating system 100 additionally includes a preheating tank 13 and a low temperature booster tank 37. The preheating tank 13 functions to preheat the glycol or other used fluid when the heating system 100 is first turned on from a cold start, for example to 180° F. The preheating tank 13 supports a fin assembly 12 mounted thereto on the air flow side of the preheating tank to radiate heat into the air flow generated by the preheating tank. The low temperature booster tank 37 also functions to provide supplemental heat to the glycol or other used fluid when the heating system 100 is first turned on from a cold start, for example to 160° F., but also during operation of the heating system as may be needed. By way of one example, the preheating tank 13 includes electric heating elements 14, 15 producing 4000 watts. By way of one example, the low temperature booster tank 37 includes electric heating element 38 producing 2000 watts.

The glycol flowing through the tubing 34 within the heating unit 50 is in series fluid communication with the preheating tank 13, the low temperature booster tank 37, and a multi-section liquid to air heat exchanger 31, although parallel paths are also contemplated. Glycol from the outlet 52 of the preheating tank 13 flows through conduit 54 into 24 V DC pump 9 for supply to the inlet end 23 of tubing 34 via conduit 56. From the outlet end 22 of the tubing 34 within the heating unit 50, the glycol flows through conduit 58 to input end 60 of the low temperature booster tank 37. From the outlet end 62 of the low temperature booster tank 37, the glycol flows through conduit 64, supplying pre-heated glycol to the liquid to air heat exchanger 31 via manifold 66. The glycol is returned to the inlet 68 of the preheating tank 13 via conduit 70 to complete the continuous closed loop. An expansion tank 16 is coupled to the manifold 66 via conduit 72 to accommodate expansion of the glycol in the heating system 100 when heated. The expansion tank 16 may include a pressure relief cap 138.

The liquid to air heat exchanger 31 is constructed from a housing 132 which may have a plurality of interdigitated fluid conduits 134 through which the heated glycol flow. Other forms of know liquid to air heat exchangers are contemplated. The microwave heating unit 50, the liquid to air heat exchange 31, the preheating tank 13 and the low temperature booster tank form a closed fluid loop for the fluid being heated within the magnetron chamber 21 as the fluid flows through the tubing 34.

As previously described, the expansion tank 16 is in fluid communication with the closed loop to accommodate expansion and contraction of fluid therein during the heating and cooling cycles of the magnetron heating system 100. The fluid within the magnetron heating system 100 may be any number of fluids, preferably nontoxic, such as water and the like. In the preferred embodiment, glycol can be used as the heating medium.

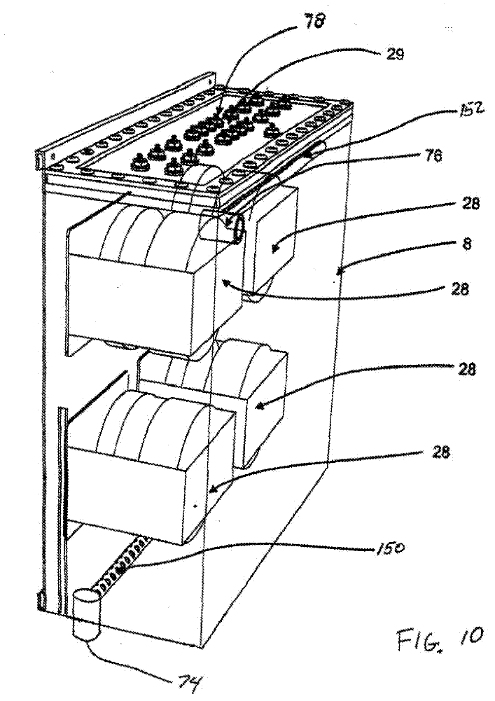

Each of the magnetrons 24 are electrically coupled to a transformer 28 such as shown in FIG. 10. The transformers 28 are preferably submerged in a cooling fluid contained within a transformer cooling tank 8 having a fluid inlet 74 connected to an internal perforated manifold 150 and a fluid outlet 76 connected to an internal perforated manifold 152. Each transformer 28 is electrically connected to a magnetron 24 via high voltage and line voltage terminals 78. The tank 8 is filled with a cooling fluid such as mineral oil and the like. In one embodiment, the transformers 28 for the upper and lower magnetrons 24 will be submerged in a mineral oil bath within a single tank 8. However, it is contemplated that the upper and lower magnetrons 24 may be immersed in separate cooling fluid tanks or two or more transformers may be provided within a single tank.

By way of one example, each transformer is a high voltage transformer, 240V/60 Hz class 220 transformers. In one embodiment, each transformer 28 includes a thermal cutout in thermal contact with the transformer windings. This provides a safety feature in case of an oil cooling failure. The windings are also made to a higher heat standard than normal microwave transformers. In use, the upper and lower magnetrons 24 may be fired simultaneously. However, it is contemplated that the upper and lower magnetrons 24 may be pulsed using a half-wave voltage doubler. The upper magnetrons 24 can be fired by the first half-wave of the line voltage and the lower magnetrons can be fired by the second half-wave. This fires the magnetrons alternatively as opposed to simultaneously.

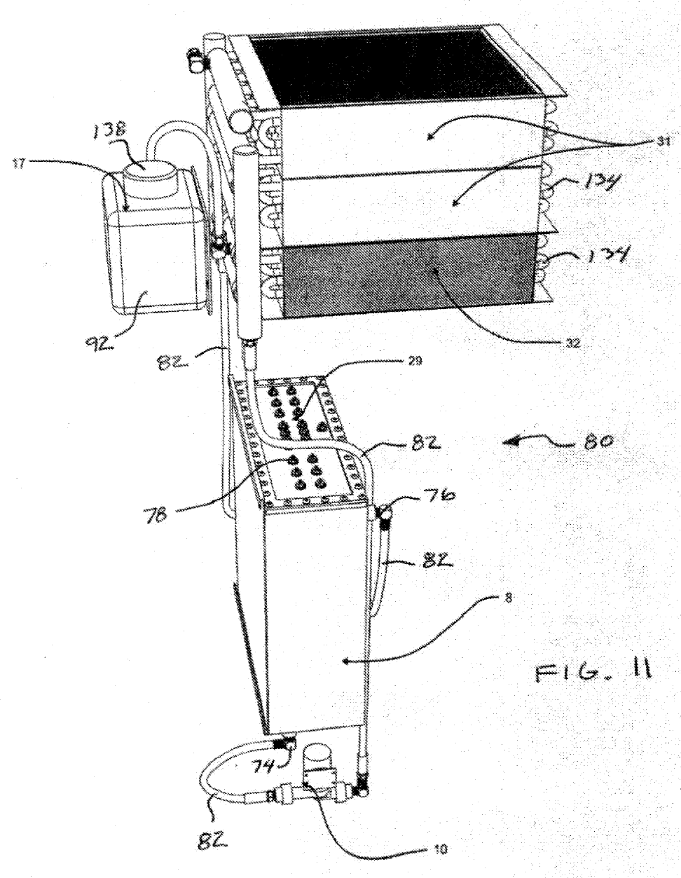

Referring to FIG. 11, the oil tank temperature is monitored and turns a 24V DC oil pump 10 on at 140° F. The high voltage and line voltage connections 78 are isolated and mounted on a Teflon plate 29. Oil level is monitored by level sensor (not shown). If low oil level is detected the heating system 100 will shut down and send a system failure and cause to a phone app and/or control panel 108. The transformer oil tank 8 maybe modular and can slide out for easy replacement.

Heat is generated within the housing 102 of the heating system 100 during operation of the magnetrons 24 and transformers 28. For the efficient operation of the heating system 100, it is contemplated that the magnetrons 24 and transformers 28 be cooled, and that the heat be recovered for use in the heating system 100. For this purpose, the heating system 100 includes fans 20 for the magnetrons 24 as previously described and a fluid cooling and heat recovery system 80 for the transformers 28 as shown in FIG. 11.

The transformer heat recovery system 80 includes the fluid filled transformer tank 8, pump 10, heat exchanger 32, an expansion tank 17 and tubing 82 interconnecting the components in fluid communication with each other. Tubing 82 couples the cooling fluid within the transformer tank 8 to the expansion tank 17 and heat exchanger 32. The heat generated by the transformers 28 within the tank 8 may be recovered by circulating the heated cooling fluid through the heat exchanger 32 of similar construction as heat exchanger 31 by operation of the pump 10. In one embodiment, the transformers 28 are maintained at an operational temperature of about 210° F. by emersion within the cooling fluid within the tank 8. The transformer heat recovery system 80 is arranged within the housing 102 underlying heat exchanger 31 as shown in FIG. 2.

The air inlet 106 may be provided with the controlled return air damper 106 for regulating the volume of return air flow into the heating system 100. The blower 7 has side air intakes 82 and an upwardly directed internal discharge opening (not shown). The liquid to air heat exchange 31 and transformer cooling heat exchanger 32 are arranged in the airflow path of the discharge opening of the blower 7 underlying air outlet 104 for heat recovery. The magnetron heating system 112, transformer tank 8, preheat tank 13, booster tank 37 and other components are located within the interior of the housing 102 as understood from the drawings and description. As previously described, the housing 102 is preferably sealed but for the air outlet 104 and air inlet 106.

Return air is pulled through the air inlet 106 by the blower 7 as generally shown in FIG. 12. The incoming air is circulated within the interior of the housing 102 picking up any internal heat from the magnetrons 24 by fans 20 and by attached fins 12 to the preheat tank 13. The internally conditioned return air is then passed through the transformer cooling heat exchanger 32 and liquid to air heat exchanger 31, being discharged through the air outlet 104. By the use of the magnetron fans 20, transformer cooling heat exchanger 32 and fins 12, the heat from operation of the transformers and magnetrons are dissipated into the return air. The aforementioned recovered heat is directed through the air outlet 104 by means of the blower 7. The heating system 100 utilizes all consequential heat generated by the system components.

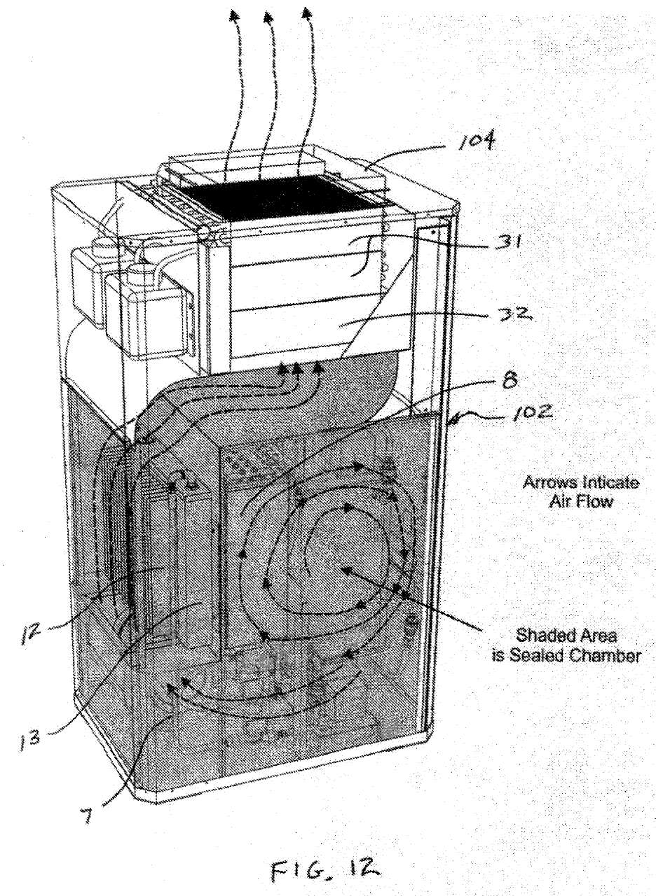

Referring to FIG. 13, another embodiment is described incorporating a forced air regeneration system. One principal of forced air regeneration is to return a portion of the outlet hot air through the return air inlet 106 using temperature controlled baffles or dampers. This approach decreases the time required to preheat the heating system 100 to operating temperature. In addition, it allows the heating system to maintain a higher temperature at the air outlet 104 during operation by approximately 10° degrees F. or higher in accordance with one embodiment.

The forced air regeneration system includes a regenerative heat recovery duct 84. The duct 84 is coupled to the return air inlet 106 having its opening controlled by the servo controlled dampers 86. The duct 84 is mounted to the housing 102 for controlling the return air to the heating system 100. The duct 84 has an air inlet 88 arranged at its upper end in communication with the air outlet 104 and an air outlet 90 in communication with the air inlet 106. Regenerative heat directed into the air inlet 88 at air outlet 104 passes through the duct 84 and is discharged into the cold air return by air outlet 90. As previously described, the returning cold air can be controlled by the temperature controlled dampers 86.

The heat regeneration system described above thus directs a portion of the outlet heat back to the cold air return. This system uses the dampers 86 in the cold air return 106 which are controlled by heat sensors located in the cooling and/or returned liquid from the liquid to air heat exchanger 31. When the system requires more preheated air, the dampers 86 restrict cold air return to draw more heated air into the system. This system yields approximately a 10° F. increase in system outlet temperature. This will maintain an outlet temperature of about 150° F. with a liquid to air heat exchanger 31 temperature of about 140° F.

By combining the magnetron heating system 112 and the cooling and heat recovery systems in a sealed housing 102, this provides a heat retention system which allows the heating system 100 to operate using minimum power. The heating system 100 is controlled by a microprocessor that constantly monitors all operating parameters of the heating system to maximize efficiency under all conditions. In operation, the internal heat recovery systems direct the heat recovered from the magnetrons 24 and transformers 28 into the warm airflow of the heating system 100, prior to the liquid to air heat exchanger 31. This process recovers approximately 95 percent of the power lost to heat.

In operation, power connects through the power entry box 1 which also contains the power relays 19. The power is then distributed to the electronics drawer 3 which contains the control circuitry. The electronics drawer is modular and slides out for easy replacement. The control circuitry then turns on the appropriate relays 19 for the operating mode at that time. When the thermostat is first turned on from a cold start, the relay 19 energizes the preheat tank 13 elements 14 15 and the 24V DC glycol pump 9 is energized, which pump remains on through the entire heating cycle. When the preheat temperature reaches 180° F., the preheat tank elements 14 15 are switched off, at which point the magnetron relays 19 are turned on. The preheat tank 13 also has the fins 12 mounted to the air flow side of the tank to radiate heat into the air flow. Under low demand conditions, 2 of the 4 magnetrons 24 will be on and alternate 1 top and 1 bottom at 10 second intervals. This prolongs the life of the magnetrons 24 and reduces energy consumption. If more heat is required, all 4 magnetrons 24 will be turned on at the same time along with the low temp glycol booster tank 37 heat element 38. The magnetrons are mounted to individual launcher waveguides 26.

Further control of the heat production is accomplished through the use of a variable speed 48V DC fan 7 controlled by the temperature of the glycol heat exchanger 31 and a servo-controlled return air damper 86. The glycol circuit has an expansion tank 16 to contain glycol expansion and return to the system. Glycol level is monitored by level sensor 18. If low level is detected the system will shut down and send a system failure and cause to a phone app. Heat production is further augmented through the use of a mineral oil filled tank 8 containing the 4 high voltage transformers 28. This heat is directed into the air flow through the lower section 32 of the 3 section exchanger. The heat from the magnetron heated glycol is directed into the air flow through the top 2 sections 31 of the 3 section exchanger. The expansion tank 17 functions to contain oil expansion and return to the system.

The oil tank temperature is monitored and turns the 24V DC oil pump 10 on at 140° F. The high voltage and line voltage connections are isolated and mounted on the Teflon plate 29. Oil level is monitored by level sensor 92. If low level is detected the system will shut down and send a system failure and cause to a phone app. The transformer oil tank is modular and slides out for easy replacement.

Heat production is further augmented by the implementation of a heat regeneration duct 84 which is mounted internally and is controlled by the return air servo-controlled return air damper 86. The magnetrons 24 are forced air cooled by 12V DC fans 20 mounted directly on each magnetron by the ducted bracket 35.

The magnetron chamber 21 houses the double helix Teflon coil 34 to increase exposure of the glycol to the microwave energy. The chamber also has the two motor 25 driven mode stirrers 33 mounted top and bottom to better distribute the microwave energy from top and bottom magnetrons to provide better exposure of the microwave energy to the glycol 24. The magnetrons are monitored individually for over and under current and over temperature. The system will be shut down for any of these conditions and send a system failure and cause to a phone app. The chamber is modular and slides out for easy replacement.

The overall effect of the heating system 100 is increased efficiency and comfort control of the heated area. This can be achieved by incorporating a number of the above described features of the present invention. In a preferred embodiment, the tubing 34 is formed into a helical coil as shown in FIGS. 4 and 5. However, other forms are contemplated. For example as shown in FIG. 14, the tubing 34 is formed into a plurality of alternating back and forth vertical flow paths. As shown in FIG. 15, the tubing 34 is formed into a plurality of alternating back and forth horizontal flow paths.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention.

What is claimed is:

1. An electromagnetic energy heating system comprising: a housing forming a chamber in communication with an air inlet and an air outlet; a magnetron heating system arranged within the chamber, wherein the magnetron heating system comprises a pair of nested tubing containing a fluid and at least one magnetron for creating electromagnetic energy in communication with the nested tubing for heating the fluid therein; a transformer operatively connected to the magnetron for the operation of the magnetron for creating the electromagnetic energy; an air to liquid heat exchanger in communication with the nested tubing; and a blower for directing air from the air inlet over the air to liquid heat exchanger to the air outlet.

2. The heating system of claim 1, wherein the nested tubing have a polygonal shape.

3. The heating system of claim 1, further including a preheating tank coupled to the nested tubing for preheating the temperature of the fluid in the nested tubing.

4. The heating system of claim 1, wherein the nested tubing are concentrically arranged.

5. The heating system of claim 1, wherein the nested tubing are formed into a plurality of helical coils.

6. The heating system of claim 1, wherein the nested tubing are formed into a plurality of alternating back and forth vertical fluid flow paths.

7. The heating system of claim 1, wherein the nested tubing are formed into a plurality of alternating back and forth horizontal fluid flow paths.

8. The heating system of claim 1, wherein the nested tubing have non-common centers.

9. The heating system of claim 1, further including a booster tank coupled to the nested tubing for boosting the temperature of the fluid in the nested tubing.

10. The heating system of claim 1, wherein the magnetron heating system comprises a first magnetron coupled to a first waveguide in communication with the nested tubing at a first end of the chamber and a second magnetron coupled to a second waveguide in communication with the nested tubing at a second end of the chamber.

11. The heating system of claim 10, wherein the magnetron heating system further includes a third magnetron coupled to a third waveguide in communication with the nested tubing at the first end of the chamber and a fourth magnetron coupled to a fourth waveguide in communication with the nested tubing at the second end of the chamber.

12. An electromagnetic energy heating system comprising: a housing forming a chamber in communication with an air inlet and an air outlet; a magnetron heating system arranged within the chamber, wherein the magnetron heating system comprises a pair of nested tubing containing a fluid, a first magnetron coupled to a first waveguide in communication with the nested tubing at a first end of the chamber and a second magnetron coupled to a second waveguide in communication with the nested tubing at a second end of the chamber, wherein the first and second magnetrons create electromagnetic energy for heating the fluid in the nested tubing; first and second transformers operatively connected to a respective one of the first and second magnetrons for the operation of the magnetrons for creating electromagnetic energy; an air to liquid heat exchanger in communication with the air outlet; and a blower for directing air from the air inlet over the air to liquid heat exchanger to the air outlet.

13. The heating system of claim 12, wherein the magnetron heating system further includes a third magnetron coupled to a third waveguide in communication with the nested tubing at the first end of the chamber and a fourth magnetron coupled to a fourth waveguide in communication with the nested tubing at the second end of the chamber; and third and fourth transformers operatively connected to a respective one of the third and fourth magnetrons for the operation of the magnetrons for creating electromagnetic energy.

14. The heating system of claim 12, wherein the nested tubing are concentrically arranged.

15. The heating system of claim 12, further including a preheating tank and a booster tank coupled to the nested tubing for respectively preheating and boosting the temperature of the fluid in the nested tubing.

16. The heating system of claim 12, wherein the nested tubing have non-common centers.

17. The heating system of claim 12, wherein the nested tubing have a polygonal shape.

18. An electromagnetic energy heating system comprising: a housing forming a chamber in communication with an air inlet and an air outlet; a magnetron heating system arranged within the chamber, wherein the magnetron heating system comprises at least a pair of nested tubing containing a fluid, a first magnetron coupled to a first waveguide in communication with the nested tubing at a first end of the chamber, a second magnetron coupled to a second waveguide in communication with the nested tubing at a second end of the chamber, a third magnetron coupled to a third waveguide in communication with the nested tubing at the first end of the chamber and a fourth magnetron coupled to a fourth waveguide in communication with the nested tubing at the second end of the chamber, wherein the first, second, third and fourth magnetrons create electromagnetic energy for heating the fluid in the nested tubing; first, second, third and fourth transformers operatively connected to a respective one of the first, second, third and fourth magnetrons for the operation of the magnetrons; an air to liquid heat exchanger in communication with the air outlet; and a blower for directing air from the air inlet over the air to liquid heat exchanger to the air outlet.

19. The heating system of claim 18, wherein the nested tubing have a polygonal shape and non-common centers.

20. The heating system of claim 18, further including a preheating tank and a booster tank coupled to the nested tubing for respectively preheating and boosting the temperature of the fluid in the nested tubing.
